(19) United States
(12) Patent Application Publication
(10) Pub. No.: US 2008/0204912 A1
(43) Pub. Date: Aug. 28, 2008

(54) Adjustable Mirror

(75) Inventor: Derk Ekenhorst, Westerkappeln (DE)

Correspondence Address: REISING, ETHINGTON, BARNES, KISSELLE, P.C., P O BOX 4390, TROY, MI, 48099-4390, US

(73) Assignee: Visiocorp Patents S.a.r.l., Luxembourg (LU)

(21) Appl. No.: 12/066,540

(22) PCT Filed: Sep. 12, 2006
(86) PCT No.: PCT/DE06/01620

§ 371 Date: Mar. 12, 2008

(30) Foreign Application Priority Data
Sep. 12, 2005 (DE) 10 2005 043 600.5

(51) Int. Cl. G02B 5/08; G02B 7/182

(52) U.S. Cl. 359/842; 359/871

(57) ABSTRACT

The invention relates to an adjustable mirror, in particular to an outside mirror of a motor vehicle, with a hinge, which links a mirror support to a mirror base so that the mirror can be twisted about an axis of rotation. An elastomeric element is arranged between the mirror base and the mirror support and is form-fitted or bonded to the mirror support and/or to the mirror base and holds the mirror support in a first position. Compression elements are arranged on the mirror support and/or on the mirror base and compress the elastomeric element when the mirror support is moved from a first position into a second position.

### BACKGROUND OF THE INVENTION

The invention is based on a priority patent application DE 10 2005 043 600.5 which is hereby incorporated by reference.

The invention relates to an adjustable mirror for motor vehicles, comprising a joint, which links a mirror support to a mirror base, so it can be pivoted about an axis of rotation. Such an embodiment is useful in particular for exterior mirrors on passenger cars.

In the state of the art, joints between a mirror base and a mirror support are known, in which a metal spring, acting in axial direction, is disposed around the rotation axis of the mirror support. This metal spring presses the mirror support in the direction towards the mirror base, wherein between the mirror base and the mirror support, a multiple teething is provided, which is loaded by means of the preloaded metal spring. The spring and the teething are used to fixate the exterior mirror in predetermined positions. These are the normal position, a parking position and an emergency position. Through the spring and the imparted preload, a holding force is provided, preventing a pivoting movement of the mirror support around the mirror base, or around the rotation axis, up to release force.

The disadvantages of this embodiment are the multi-component construction of the mirror and the difficult assembly with the requirement to preload the compression spring.

### SUMMARY OF THE INVENTION

It is the object of the present invention, to provide an adjustable mirror, which is provided lighter, and which can be assembled in a simpler manner.

According to the invention, this object is accomplished through the features of an adjustable mirror, in particular an exterior mirror for motor vehicles, comprising a joint, linking a mirror support pivotable around a rotation axis to a mirror base, wherein between the mirror base and the mirror support, an elastomeric element is disposed, which is fixated in a form locked manner at the mirror support and/or at the mirror base, or in a materially continuous manner at the mirror support, or at the mirror base, and holds the mirror support in a first position, and compression elements, are disposed at the mirror support and/or at the mirror base, compressing the elastomeric element, when the mirror support is moved from a first position into a second position.

Advantageous embodiments and refinements of the invention are described in the dependent claims. A mirror according to the invention for motor vehicles comprising joint, connecting a mirror support to a mirror base, pivotable around a rotation axis, provides that an elastomeric element is disposed between the mirror base and the mirror support, which is mounted in a form locked or bonded manner to the mirror support and/or the mirror base. The mirror support is thus held in a first position. At the mirror support and/or the mirror base at least one compressing element is disposed, compressing the elastomeric element during a movement of the mirror support from the first position into a second position. Thereby it is possible to reduce the number of components for a mounted exterior mirror and to simplify the assembly process itself, since the number of components is reduced and the components themselves can be provided lighter.

A refinement of the invention provides, that the compression elements comprise a component, which is effective or directed in a radial manner with respect to the rotation axis, thus provided as protrusions at the mirror base and/or the mirror support. The elastomeric element or the elastomeric elements are then held in bulges, or between two protrusions, so that during a movement of the mirror support, relative to the mirror base around the axis of rotation, a relative movement of the elastomeric element, either relative to the mirror base, or relative to the mirror support is performed. The mirror base then rotates in the elastomeric element, or the mirror support rotates around the elastomeric element. By means of the radially oriented protrusions, the elastomeric element is radially compressed, and thus acts against an adjustment around the rotation axis, with a force which can be predetermined.

For a form locked fixation, and for providing radially effective protrusions, it is provided that the mirror base and/or the mirror support comprise a non-circular or polygon cross sections in the portion of the support of the elastomeric element. The mirror base can e.g. be surrounded by the elastomeric element, wherein the cross section of the mirror base can be provided as a regular polygon, possibly with rounded corners. The number of corners thus depends on the desired adjustment angle. If the adjustment angles in driving direction or against driving direction have different size, also irregular cross section contours can be provided. A possible embodiment provides a hexagonal cross section contour of the mirror base.

A possible embodiment for disposing the elastomeric element in the mirror support provides that the elastomeric element is inserted form locked into the mirror support, in particular surrounded by the mirror support, wherein the mirror support has a multi-tooth contour, into which the elastomeric element is inserted in a form locked manner.

In order for the mirror base not to have to slide directly on the elastomeric element, since the sliding capability of the surface is reduced by means of the elastic deformability of the elastomeric element, it is provided in a refinement of the invention, that between the mirror base, or the mirror support and the elastomeric element, a coupling element is disposed, which slides on the exterior contour of the mirror base or of the mirror support and experiences a radial displacement in order to compress the elastomeric element. The elastomeric element is preferably manufactured from an elastically deformable plastic or rubber material, e.g. from an elastically deformable plastic foam or from a vulcanized rubber element. The coupling element can be integrated in the elastomeric element, e.g. integrally formed, or provided as a component in a two-component molding process, together with the elastomeric element.

A particularly advantageous embodiment of the invention provides that the elastomeric element is integrally molded at the mirror support, or at the mirror base, in particular as a component in a two-component injection molding process, together with the mirror base or together with the mirror support, so that an integration of the elastomeric element into the mirror base or the mirror support is performed. Thereby, it is possible that only two components, thus the mirror base and the mirror support, have to be joined, without having to consider another component during assembly.

It is provided for vibration absorption of the mirror or the mirror support that the elastomeric element is mounted to the mirror base and/or the mirror support under a preload, wherein the preload acts in circumferential direction. The preload is adjusted, so that certain vibration absorption is accomplished, but the mirror support is safely held relative to the mirror base. A preload is also provided in radial direction.

### BRIEF DESCRIPTION OF THE DRAWINGS

Subsequently, two embodiments of the invention are described in more detail, based on the appended figures. It is shown in:

FIG. 1 a mirror base in a perspective view;

FIG. 2 an assembled mirror support on a mirror base according to FIG. 1 in a perspective partial sectional view;

FIG. 3 an assembled mirror support on the mirror base in top view in normal position;

FIG. 4 a mirror support according to FIG. 3 in rotated position;

FIG. 5 a perspective partial sectional view of a second embodiment; and

FIG. 6 a sectional view of a mirror according to FIG. 5.

### DETAILED DESCRIPTION OF THE DRAWINGS

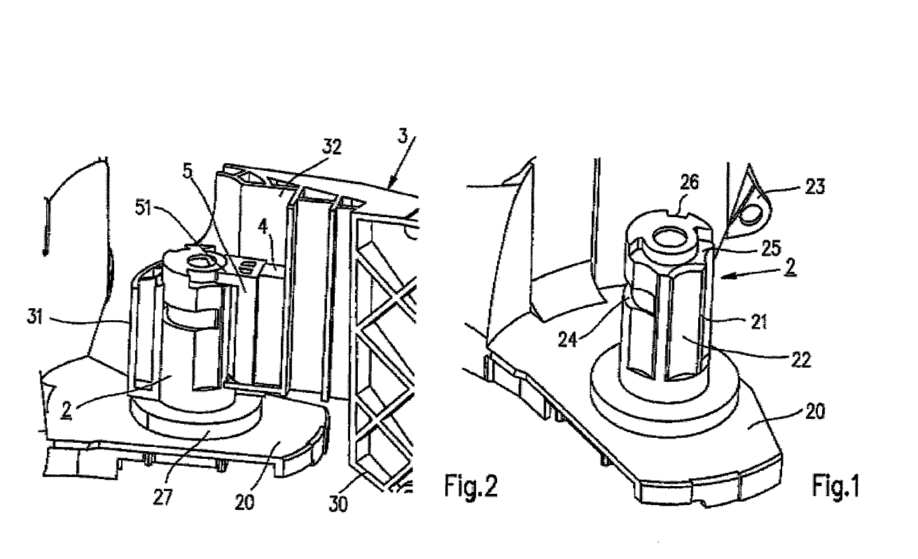

In FIG. 1 a mirror base 2 is shown, which is provided on a base 20, at which a mounting portion 23 for mounting the mirror base 2 onto a motor vehicle, in particular a car, is provided. The mounting portion 23, the base 20, and the mirror base 2 are preferably provided as a one-piece plastic components. The mirror base 2 substantially extends perpendicular to the substantially horizontally oriented base 20, and forms a rotation axis, comprising recesses 22 or protrusions 21 in axial direction. In the present invention, these recesses 22 or protrusions 21 are provided opposite to the mounting portion 23, however, they can also be provided symmetrical at the mirror base 2. On the side facing the mounting portion 23, an axial lock 24 in the form of a groove is provided, by means of which it is prevented, that a mirror support 3, supported at the mirror base 2, as shown in FIG. 2, can disengage in axial direction from the mirror base 2. For this purpose, a protrusion, which is not shown, is provided in a mirror base receiver 31, which is brought into engagement with the axial lock 24 through an axially extending insertion groove 26.

In FIG. 2, a mirror support 3 is shown in a perspective partial cut view, which is mounted to a mirror base 2. The mirror support 3 comprises the mirror base receiver 31, besides a mirror glass receiver 30, wherein said mirror base receiver 31 encloses the mirror base 2 in assembled state. The mirror base receiver 31 rests on a shoulder 27, which extends from the base 20. The mirror support 3 can basically be pivoted around the mirror base 2. In order to hold the mirror support 3 in a desired position, an elastomeric element 4 is inserted into a groove 32, which is provided in the mirror support 3, wherein said elastomeric element enters into form locked engagement with the bulges 22, through a coupling component 50, which is mounted or preferably bonded to said elastomeric element or integrally provided therewith. Thus, a form locked elastic coupling between the mirror base 2 and the mirror support 3 is assured through the elastomeric element 4 in the embodiment according to FIG. 2 in connection with the coupling component 5. The elastomeric element 4 in assembled state is slightly compressed, so that a force in radial direction is exercised between the mirror base 2 and the mirror support 3. Thereby, the mirror support 3 is held in the initially adjusted position, which is determined by the disposition of the recesses 22 or the bulges.

In the illustrated embodiment, three recesses 22 are provided in the mirror base 2, into which the coupling component 5 can engage. The center recess 22 determines the normal position, while the recess in counterclockwise direction defines an emergency position and the one in clockwise direction defines a parking position, wherein the mirror support 3 is folded. The recesses 22 can be evenly spaced from one another, alternatively a disposition of the recesses 22 is provided, so that they are unevenly spaced from one another, so that a different tilting of the mirror support 3 from the normal position is facilitated.

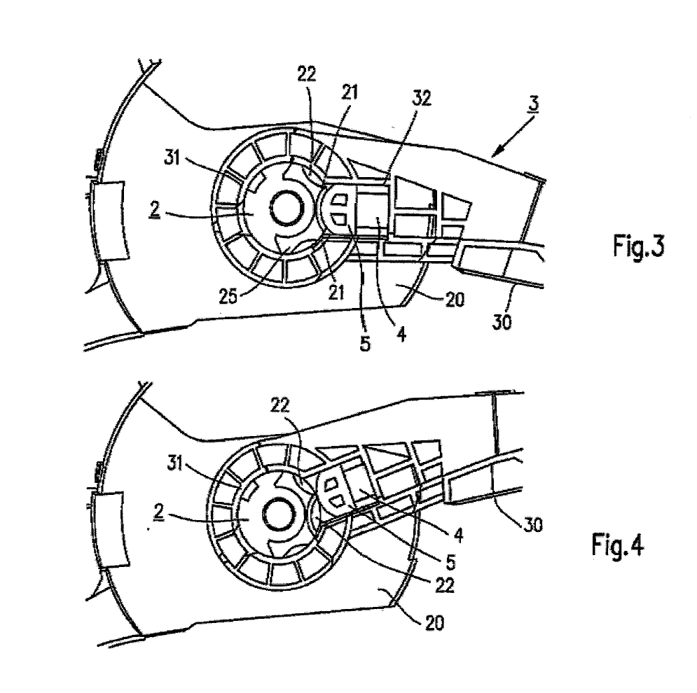

In FIG. 3 a mirror support 3 is shown in normal position in top view, wherein said mirror support is pivotably supported at the mirror base 2. In FIG. 3, the three recesses or two protrusions 21 are visible. The contour of the recesses 22 is slightly rounded.

The form stable mirror support 3, which is also integrally provided as an injection molded part, comprises a mirror base receiver 31, surrounding the mirror base 2, which is substantially provided annular, and at which the mirror glass receiver 30 is integrally connected through an arm. The elastomeric element 4, which is slightly compressed in radial direction, contacts the mirror base 2 through the coupling element 5, and is engaged in the groove 32 of the mirror support 3 in a form locked manner. In a supplemental manner, the elastomeric element 4 can be glued into the mirror support 3, or can be jointly formed in a two-component injection molding method.

The coupling component 5 comprises a contour, which corresponds to the bulge 22. By means of the rounded embodiment, the mirror support 3 is held in the respective position, due to the preload acting in a radial direction. In the face portion of the mirror base 2 a support block 25 is formed, on which a shoulder 51 of the coupling component 5 is supported, and on which it slides along during pivoting the mirror support 3.

In order to reach e.g. an emergency position from the normal position shown in FIG. 3, a pivoting of the mirror support 3 has to be performed counterclockwise around the mirror base 2. Due to the contour of the recess 22, and due to the protrusions 21 protruding beyond, the coupling component 5 slides along on the exterior contour of the mirror base 2. Next to a force component acting in circumferential direction, a radially acting force component has to be imparted, in order to compress the elastomeric element 4. In FIG. 4, it is shown in an almost maximally compressed position, in which an almost maximum radially acting force component acts on the mirror base 2, or on the protrusion 21, on which the coupling component 5 slides along. When the mirror support 3 is pivoted further counterclockwise, e.g. because a vehicle, or other traffic passes the vehicle too closely and collides with the exterior mirror, the coupling component 5 is moved beyond the protrusion 21, snaps into the upper recess 22, and holds the mirror support 3 in the emergency position. Accordingly, a displacement back into the normal position, or into a folded position towards the outside contour of the vehicle occurs in opposite direction.

Instead of a two-component embodiment of the elastomeric element 4 in combination with the coupling component 5, it is provided that the elastomeric element 4 is integrally formed either at the mirror support 3, or at the mirror base 2. It is also possible that a sliding of the elastomeric element 4 does not occur on the mirror base 2, but on the mirror support 3.

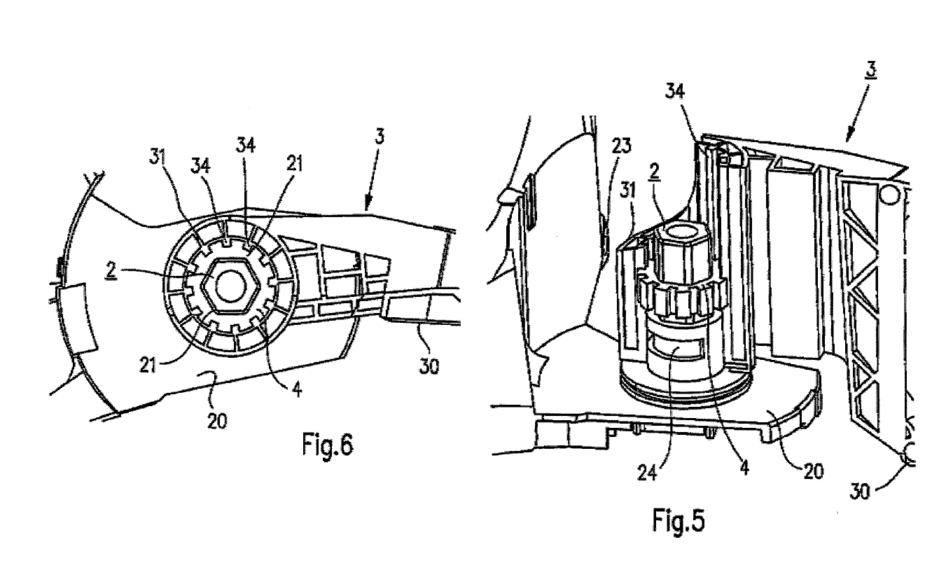

An alternative embodiment of the invention is shown in FIG. 5, in which a star shaped elastomeric element 4 is provided instead of a block shaped elastomeric element 4. At the exterior contour, which is round, groove shaped recesses are provided, engaging into correspondingly shaped form locking elements 34 in the mirror support 3 in the inner contour of the mirror base receiver 31. The inner contour of the elastomeric element 4 is provided hexagonal and corresponds to the exterior contour of the mirror base 2. The elastomeric element 4 is fitted under a preload in axial and also in circumferential direction, preferably at the mirror support 3, and by means of this preload, next to a fixation of the illustrated normal position, also a damping relative to vibrations is performed, so that the mirror support 3 is supported in a damped and stable manner at the mirror base 2.

In order to effectuate an adjustment of the mirror support 3 clockwise or counterclockwise, a moment is generated through imparting a force onto the mirror support 3. The edges of the mirror base 2 serve as protrusions 21, over which the portions of the elastomeric element 4 have to slide with an increased material thickness, so that a corresponding effect, as in the embodiment according to the FIGS. 1 through 4 is accomplished. An adjustment by 60° respectively is possible in the existing polygon. In another polygonal embodiment, the adjustment angle increases, or decreases accordingly.

In particular in an embodiment of the elastomeric element 4 as an integral component, either of the mirror support 3, or of the mirror base 2, a reduction of the components is accomplished. Furthermore, the elastomeric element 4 also assumes the function of a vibration damper, besides a holding function, so that a functional integration is performed by the component, which reduces the cost of the entire exterior mirror. The elastomeric element 4 is only loaded by pressure, and can be provided as plastic foam material, or as a rubber material. In the embodiment according to FIGS. 4 and 5, the fixation in the mirror support 3 is performed, so that the elastomeric element 4 does not perform a relative movement with respect to the mirror support 3.

What is claimed is:

1. An adjustable mirror, in particular an exterior mirror for motor vehicles, comprising a joint, linking a mirror support pivotable around a rotation axis to a mirror base, wherein between the mirror base and the mirror support, an elastomeric element is disposed, which is fixated in a form locked manner at the mirror support and/or at the mirror base, or in a materially continuous manner at the mirror support, or at the mirror base, and holds the mirror support in a first position, and compression elements, are disposed at the mirror support and/or at the mirror base, compressing the elastomeric element, when the mirror support is moved from a first position into a second position.

2. A mirror according to claim 1, wherein the compression elements comprise a component, radially facing towards the rotation axis.

3. A mirror according to claim 1, wherein the compression elements are provided as protrusions at the mirror base and/or at the mirror support.

4. A mirror according to claim 1, wherein the mirror base and/or the mirror support comprise a non-circular, or polygonous cross section.

5. A mirror according to claim 1, wherein between the elastomeric element and the mirror base, and/or the mirror support a coupling element is disposed.

6. A mirror according to claim 1, wherein the mirror base is surrounded by the elastomeric element, and the cross section in the support portion of the elastomeric element is provided as a regular polygon, in particular a hexagon.

7. A mirror according to claim 1, wherein the elastomeric element is inserted into the mirror support.

8. A mirror according to claim 7, wherein the mirror support comprises a multi-tooth contour, into which the elastomeric element is inserted in a form locked manner.

9. A mirror according to claim 1, wherein the elastomeric element is mounted to the mirror base, and/or the mirror support, under a preload.

10. A mirror according to claim 1, wherein the elastomeric element is made from an elastically deformable plastic or rubber material.

11. A mirror according to claim 1, wherein the elastomeric element is molded to the mirror support, or to the mirror base, in particular integrated into the mirror base, or into the mirror support in a two-component injection molding method.
